(19) United States
(12) Patent Application Publication
(10) Pub. No.: US 2007/0104992 A1
(43) Pub. Date: May 10, 2007

(54) Solid oxide fuel cell stack of modularized design

(75) Inventors: Yu-Ching Tsai, Donggang Township (TW); Lieh-Kwang Chiang, Tainan City (TW); Chia-Lieh Huang, Hualien City (TW); Chien-Hsiung Lee, Longtan Township (TW); Wei-Ping Huang, Taipei City (TW)

Correspondence Address: BRUCE H. TROXELL, SUITE 1404, 5205 LEESBURG PIKE, FALLS CHURCH, VA, 22041, US

(73) Assignee: Institute of Nuclear Energy Research Atomic Energy Council

(21) Appl. No.: 11/385,817

(22) Filed: Mar. 22, 2006

(30) Foreign Application Priority Data
Nov. 8, 2005 (TW) 094139182

(51) Int. Cl. H01M 8/12; H01M 8/24

(52) U.S. Cl. 429/32; 429/35

(57) ABSTRACT

A solid oxide fuel cell stack of modularized design is disclosed, which comprises: at least a fuel cell cassette; an air tank, for providing air to the fuel cell stack while being used for receiving the fuel cell cassette; a fuel tank, for providing fuel to the fuel cell stack; and a set of conducting strips, connecting to the fuel cell cassette for transmitting electricity out of the fuel cell stack; wherein the fuel cell cassette further comprises a planar fuel cell and a case, being used for receiving the planar fuel cell. Preferably, the planar fuel cell is composed of two membrane electrode assembly (MEA), each having an anode electrode, a cathode electrode, and a nickel mesh with an extending bar, sandwiched between the two MEAs, whereas the anode electrode of one of the two MEAs is placed facing the anode electrode of another MEA.

### FIELD OF THE INVENTION

The present invention relates to a modularized solid oxide fuel cell stack, and more particularly, to a fuel cell stack comprising a plurality of fuel cell cassettes, each being substantially a planar solid oxide fuel cell arranged inside a detachable cassette, which can facilitate the maintenance and replacement problems troubling conventional fuel cell stack and thus reduce the cost of maintaining the same.

### BACKGROUND OF THE INVENTION

Fuel Cells have emerged as one of the most promising technologies for the power source of the future since it has the property of low pollution and high efficiency of energy transformation. Fuel cells can be categorized into proton exchange membrane fuel cell (PEMFC), alkaline fuel cell (AFC), phosphoric acid fuel cell (PAFC), Molten Carbonate Fuel Cell (MCFC), and solid oxide fuel cell (SOFC) according to the types of eletrolyte used thereby, wherein the PEMFC, the AFC, and the PAFC is operating at a low temperature range, the MCFC is operating at an intermediate temperature range, and the SOFC is operating at a high temperature range. In addition to the abovementioned fuel cells, there are direct methanol fuel cell (DMFC) and metal-air fuel cell, and so on. Among the different types of fuel cells, the high temperature solid oxide fuel cell (SOFC) is particularly interesting due to the following factors: (1) The highest degree of efficiency; and (2) The arising heat at high temperatures can be furtherly used in many different ways. Due to the mentioned advantages, the SOFC is being studied and developed for its application in the fuel cell technology.

Conventionally, an SOFC is constructed with two porous electrodes which sandwich an electrolyte. In an SOFC, fuel, e.g. methane, and oxidant, e.g. air, are preheated to a temperature close to the operating temperature of the SOFC, i.e. between 600° C.˜1000° C., and then being fed into the SOFC. When an oxygen molecule contacts the cathode/electrolyte interface as the air flows along the cathode (which is therefore also called the “air electrode”), it catalytically acquires four electrons from the cathode and splits into two oxygen ions. The oxygen ions diffuse into the electrolyte material and migrate to the other side of the cell where they encounter the anode (also called the “fuel electrode”). The oxygen ions encounter the fuel at the anode/electrolyte interface and react catalytically, giving off water, carbon dioxide, heat, and—most importantly—electrons. The electrons transport through the anode to the external circuit and back to the cathode, providing a source of useful electrical energy in an external circuit. Furthermore, the exhaust air with temperature higher than 700° C. and residual fuel, both being discharged at the exit of the SOFC, can be recycled for other usages.

Two possible design configurations for SOFCs have emerged: a planar design and a tubular design. In the tabular SOFC, components are assembled in the form of a hollow tube so that the tabular SOFC can keep good airtight even when subjecting to a high-temperature ambient, but is suffered by the problems of low power density and high internal impedance. On the other hand, the planar SOFC can provide good power density and preferred efficiency, but it is troubled by the difficulty of keeping airtight. The key factors of a planar SOFC include: a membrane electrode assembly (MEA), being composed of an anode, a cathode and an electrolyte; a manifold plate, for guiding fuel and air; and other relating parts, capable operating while being subjected to high temperature. Since the voltage output of a single fuel cell is far to low for many applications, it frequently becomes necessary to connect multiple fuel cells in series, parallel or series/parallel configuration as those disclosed in U.S. Pat. No. 6,296,962 B1, U.S. Pat. No. 6,649,296 B1, and U.S. Pat. application Ser. No. 2005/0089371 A1. However, gas-tight connections must be incorporated in the fuel cell stack to allow for a safe and efficient flow of reaction gases. Typically, a group of individual fuel cells are welded, soldered or otherwise bonded together into a single unitary stack by the use of glass ceramics capable of enduring 700° C.˜1000° C. operating temperature. Accordingly, if one cell must be removed and replaced, such as for testing or maintenance, the remaining cells are destroyed in the process. This leads to significant losses in time and money.

### SUMMARY OF THE INVENTION

In view of the disadvantages of prior art, the primary object of the present invention is to provide a modularized solid oxide fuel cell stack comprising a plurality of fuel cell cassettes, each being substantially a planar solid oxide fuel cell arranged inside a detachable cassette, by which the maintenance and replacement problems caused by the use of glass ceramics for enabling the airtight of the fuel cell stack can be solved and thus the cost of maintaining the same can be reduced.

To achieve the above object, the present invention provides a modularized solid oxide fuel cell stack comprising: at least a fuel cell cassette; an air tank, for providing air to the fuel cell stack while being used for receiving the fuel cell cassette; a fuel tank, for providing fuel to the fuel cell stack; and a set of conducting strips, connecting to the fuel cell cassette for transmitting electricity out of the fuel cell stack; wherein the fuel cell cassette further comprises a planar fuel cell and a case, being used for receiving the planar fuel cell. Preferably, the planar fuel cell is composed of two membrane electrode assembly (MEA), each having an anode electrode an a cathode electrode, and a nickel mesh with an extending bar, sandwiched between the two MEAs, whereas the anode electrode of one of the two MEAs is placed facing the anode electrode of another MEA.

In a preferred embodiment of the invention, the modularized solid oxide fuel cell stack comprise a plurality of serial-connected fuel cell cassettes; wherein the serial connection is achieved by connecting the extending bar of the nickel mesh of any one of the plural fuel cell cassette to the case of a neighbor fuel cell cassette. By serially connecting more than two fuel cell cassettes, the output voltage of the fuel cell stack can be increased.

Preferably, the case of each fuel cell cassette further has a plurality of manifolds arranged therein, for guiding air to flow and distribute uniformly along the cathodes of the corresponding planar fuel cell received therein.

Preferably, the number of the manifolds is dependent on the characters of the membrane electrode assembly of the planar fuel cell.

Preferably, the case is made of a non-precious metal such as stainless steel, or a high temperature resisting material such as Inconel 600/625, or a conductive material with thermal expansion coefficient similarly to that of the fuel cell.

In a preferred embodiment of the invention, the air tank further comprises: a main air chamber; at least a air duct, for guiding high temperature air to flow into the air tank; and a hollow air distribution chamber, being arranged at a position between the main air chamber and the air duct; wherein a plurality of air holes are arranged at a surface of the air distribution chamber facing toward the main air chamber.

In another preferred embodiment of the invention, the fuel tank further comprises a hollow fuel distribution chamber, having a plurality of fuel holes arranged on a surface thereof facing toward the fuel cell; and a fuel duct, for guiding high temperature fuel to flow into the hollow fuel distribution chamber.

Preferably, an air react channel is formed between the air tank and the cathode of fuel cell cassette, and a fuel reaction channel is formed between the fuel tank and the anode of the fuel cell cassette, whereas an air tight seal for isolating the air react channel from the fuel reaction channel while keeping both air tight.

Preferably, the air tight seal can be accomplished by sintered glass ceramics or mica spacers.

In a preferred aspect, the fuel tank further comprises a residual fuel chamber with a fuel exiting duct, the residual fuel chamber being connected to the fuel cell cassette; wherein the residual fuel is collected and accumulated by the residual fuel chamber to be guided out of the fuel tank by the fuel exiting duct. Moreover, the air tank further comprises an air exiting duct for guiding the reacted air of the fuel cell cassette out of the air tank.

In a preferred aspect, the air tank further comprises an after-burn chamber, for enabling residual fuel to burn therein.

Preferably, the residual fuel and the reacted air are guided to flow in the after-burn chamber to be burned therein.

Preferably, the after-burn chamber further comprises a porous ceramics arranged therein for enhancing the burning efficiency of the residual fuel and air while enhancing the homogeneity of temperature distribution.

Preferably, the conductive strips are made of a metal of high temperature resistance.

Other aspects and advantages of the present invention will become apparent from the following detailed description, taken in conjunction with the accompanying drawings, illustrating by way of example the principles of the present invention.

### BRIEF DESCRIPTION OF THE DRAWINGS

FIG. 1 shows an assembly of a modularized solid oxide fuel cell stack according to a preferred embodiment of the present invention.

FIG. 1A shows an assembly of a modularized solid oxide fuel cell stack with two air ducts according to another preferred embodiment of the present invention.

FIG. 2 is an exploded view of a modularized solid oxide fuel cell stack according to the present invention.

FIG. 3A to FIG. 3C are schematic diagrams depicting the sequential assembling of a fuel cell cassette of the present invention.

FIG. 4A to FIG. 4B are schematic diagrams depicting the steps of sequentially assembling two fuel cell cassettes to an air tank according to the present invention.

FIG. 5 is a three dimensional view of an air tank according to a preferred embodiment of the invention.

FIG. 6 is the back view of the air tank of FIG. 5.

### DESCRIPTION OF THE PREFERRED EMBODIMENT

For your esteemed members of reviewing committee to further understand and recognize the fulfilled functions and structural characteristics of the invention, several preferable embodiments cooperating with detailed description are presented as the follows.

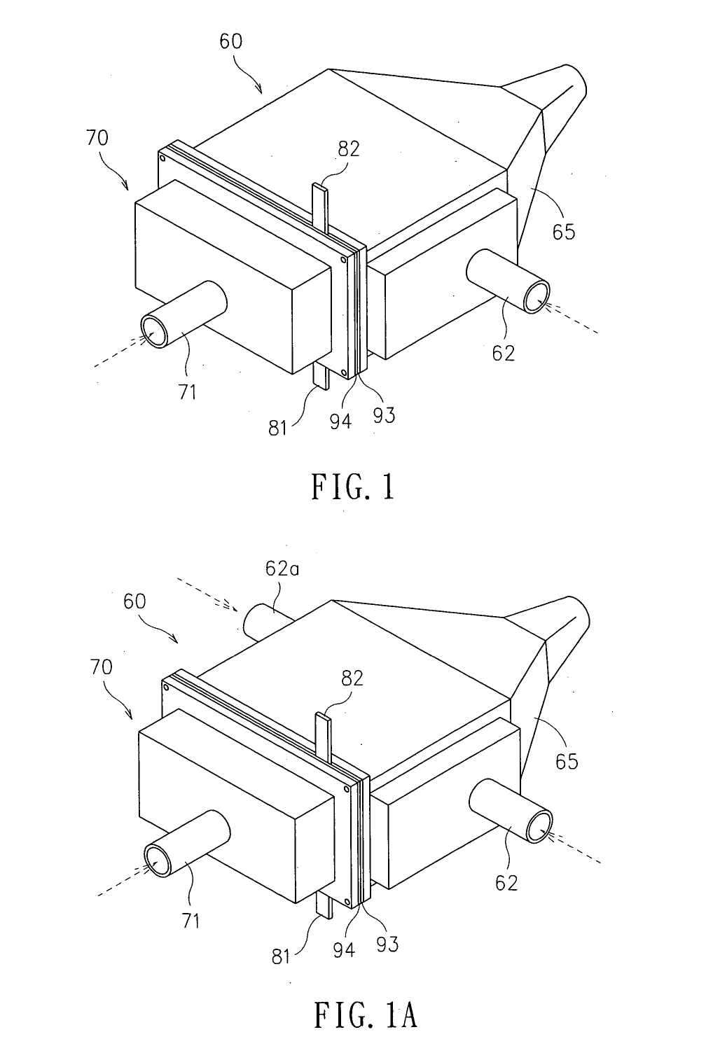

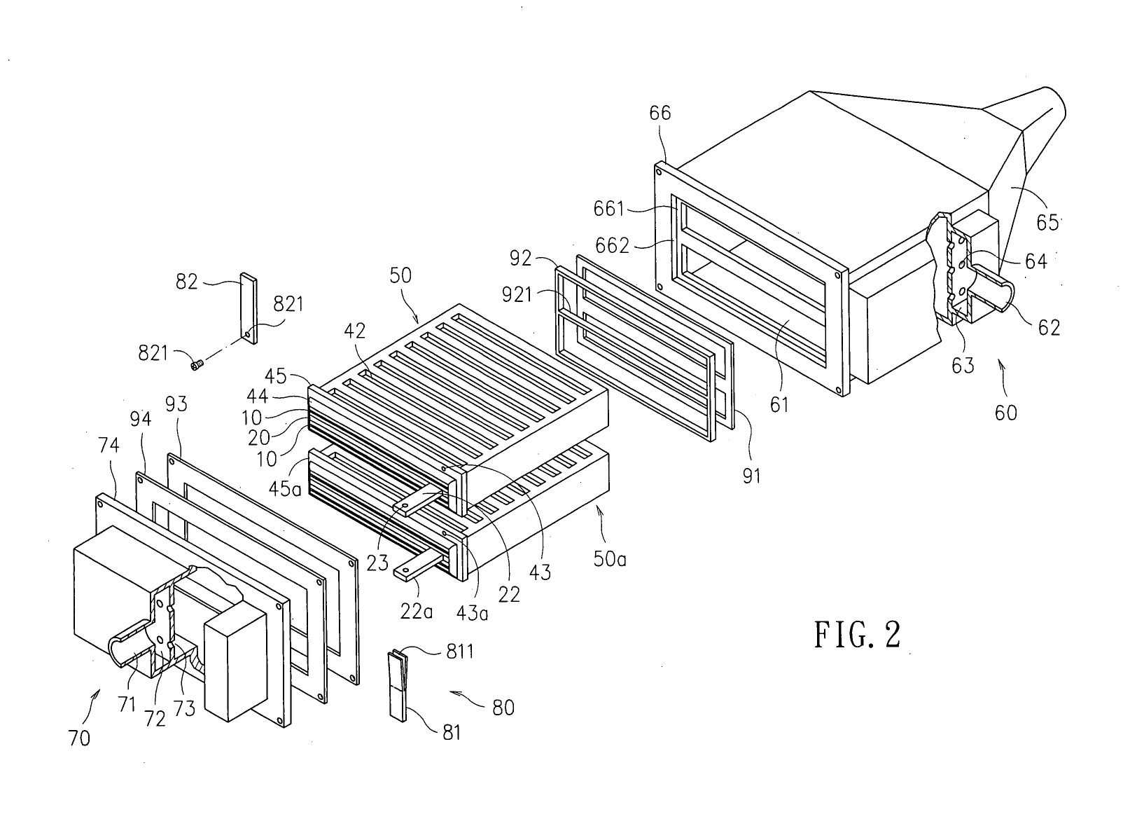

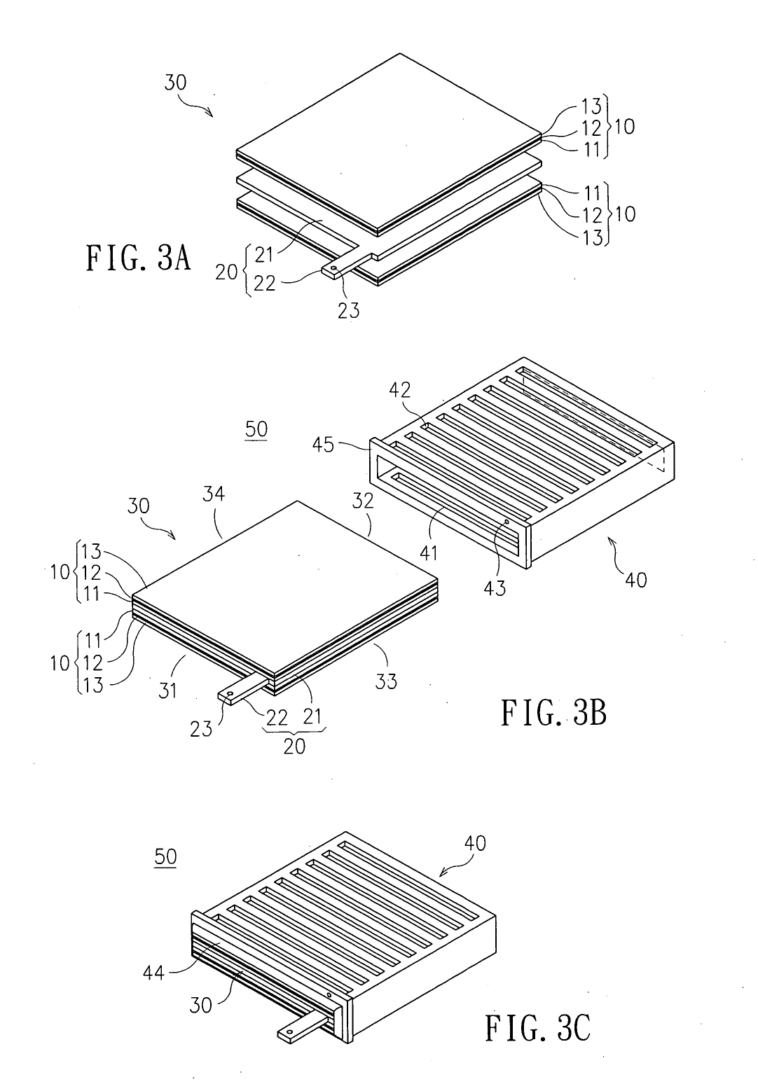

Please refer to FIG. 1 and FIG. 2, which are respectively an assembly of a modularized solid oxide fuel cell stack of the present invention and a an exploded view of FIG. 1. As seen in FIG. 1 and FIG. 2, a modularized solid oxide fuel cell stack is comprised of two fuel cell cassettes 50, 50a, an air tank 60, a fuel tank 70 and a set of conductive strips 80. It is noted that the configuration of the fuel cell cassette 50 is the same as that of the fuel cell cassette 50a, and thus the general configuration of fuel cell cassette can be represented by that of the fuel cell cassette 50 as seen in FIG. 3A˜FIG. 3C, in that the fuel cell cassette 50 is comprised of a fuel cell 30 and a case 40.

In FIG. 3A˜FIG. 3C, the fuel cell 30 is a rectangle planar cell, being comprised of two membrane electrode assembly (MEA) 10 and a nickel mesh 20 sandwiched between the two MEAs. Each of the two MEAs 10 is a three-tier structure, comprising an anode 11, a solid electrolyte 12 and a cathode 13, and the nickel mesh 20 is composed of main body 21, sandwiched between the two MEAs, and an extending bar 22, extruding out of the sandwich structure of two MEAs 10 and the main body 21. Moreover, a hole 23 is arranged on the extending bar 22. The major function of the nickel mesh 30 is to enabling nature gas, hydrogen or any other common fuel used in the fuel cell stack to be distributed homogeneously on the surfaces of the anodes by using the porous nature of the nickel mesh 30, and the same time without adversely affecting the conductive of the anode 11 cause by the generation of oxide layer thereon since it is still being enable to be subject to a redox ambient. In addition, the electrons are transport through the anodes 11 to the external circuit by the nickel mesh 20. As seen in FIG. 3B, the anode 11 of one of the two MEAs 10 is placed facing the anode 11 of another MEA 10 while sandwiching the nickel mesh 20 therebetween with the extending bar 22 extruding out of the sandwiched structure of two MEAs 10 and the main body 21. The side of the sandwiched structure where the extending bar 22 is extruding is used as fuel inlet 31 while the side there of opposite to the fuel inlet 30 is used as the fuel outlet 32, so that fuel can be fed into the sandwiched structure through the nickel mesh 20 of the fuel inlet 31 and flow out of the same through the nickel mesh 20 of the fuel outlet 32. In order to prevent fuel to leakage from the two sides 33, 34 other than the fuel inlet 31 and the fuel outlet 32 of the sandwiched structure, the other two sides 33, 34 can be sealed by the use of sintered glass ceramics or mica spacers.

The case 40, being an open-end hollow structure, has a connecting plate 45 arranged in front of the case, whereas the dimension of the connecting plate 45 is larger than that of the cross section of the case 40. There is a recess 43 being arranged on the connecting plate 45. Preferably, the case 40 is made of a non-precious metal such as stainless steel, or a high temperature resisting material such as Inconel 600/625, or a conductive material with thermal expansion coefficient similarly to that of the fuel cell. The space 41 formed inside the case 40 is used for receiving the fuel cell 30. Furthermore, the case 40 further has a plurality of manifolds 42 arranged on the top and bottom thereof and channeling from the front of the case to the back thereof, for guiding air to flow and distribute uniformly along the cathodes of the corresponding planar fuel cell received therein. In order to achieve an optimum matching, the number of the manifolds 42 and the size of each manifold 42 are adjusted according to the characters of the corresponding membrane electrode assembly 10. As seen in FIG. 3B and FIG. 3C, as the fuel cell 30 is inserted into the case 40, the extending bar 22 of the nickel mesh 20 will extrude out of the case 40 while the inner sides of the case 40 are in compact contact to the cathodes 13 of the fuel cell 30, such that air can be guided to flow in the case 40 through the plural manifolds and to react with the cathodes 13. In order to prevent the air from leakage and thus contact the anodes 11 of the fuel cell 30, the gaps formed between the case 40 and the inserted fuel cell 30 at the fuel inlet 31 should be sealed. The airtight seal 44 can be achieved by sintering glass ceramics coated at the joint of the connecting plate 45 and the fuel cell 30.

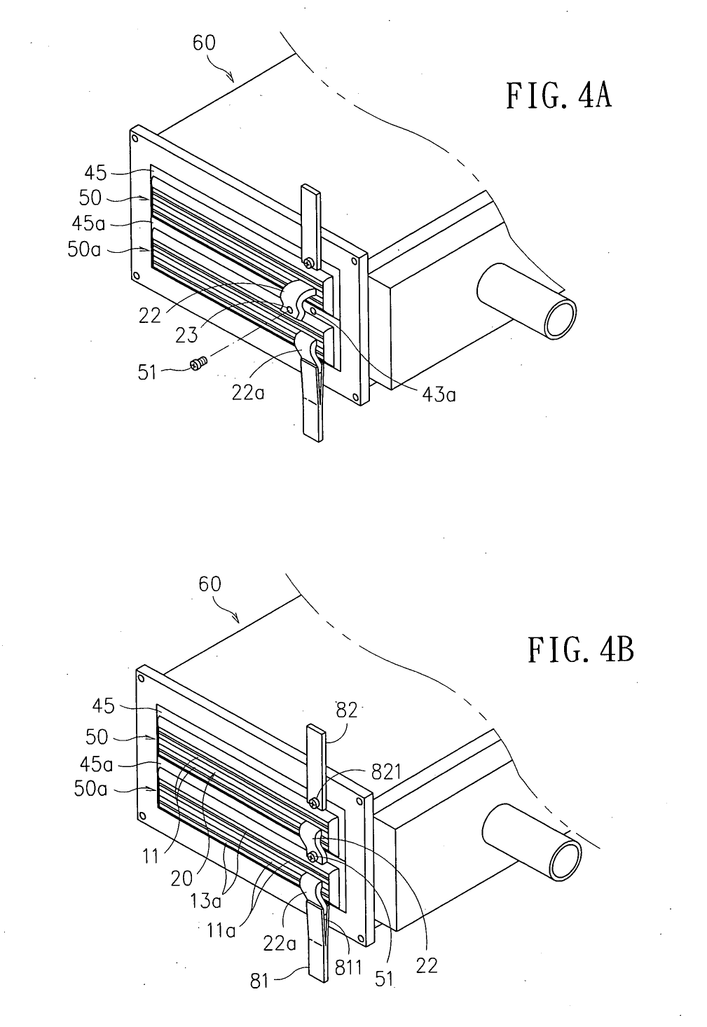

Generally, a fuel cell can only provides voltage of 0.6˜0.9V. Therefore, in order to increase the output voltage of the modularized solid oxide fuel cell stack, it is preferred to connect a plurality of fuel cell in serial so as to form a fuel cell stack. Please refer to FIG. 4A and FIG. 4B, which are schematic diagrams depicting the steps of sequentially assembling two fuel cell cassettes 50, 50a to an air tank 60 according to the present invention. In FIG. 4A and FIG. 4B, as the two fuel cell cassette 50, 50a are stacked to be inserted into the air tank 60, the flexibility of extending bars 22, 22a enabling the same to be bended downwardly so as to fix the hole 23 of the extending bar 22 to the recess 43a of the connecting plate 45a connected to the lower fuel cell cassette 50a by a screw 51. By which, the electrons generated from anode II of the upper fuel cell cassette 50 is collected by the corresponding nickel mesh 20 to be transmitted to the connecting plate 45a of the lower fuel cell cassette 50a, and then being transmitted to the case 40a thereof for being provided to the cathode 13a thereof. It is noted that the number of fuel cell cassette to be used in the modularized fuel cell stack of the invention is not limited by the two fuel cell cassettes 50, 50a, which can be as many as required, and thus the size of any components of the modularized fuel cell stack of the invention can be adjusted accordingly.

The configuration of the air tank 60, the fuel tank 70, the conductive strips 80 and the two fuel cell cassettes 50, 50a is illustrated with reference to the diagrams shown in FIG. 2 and FIG. 4B. As seen in FIG. 2, the air tank 60 having a front panel 66 arranged in front thereof further comprises: a main air chamber 61 for receiving the two fuel cell cassettes 50, 50a; at least a air duct 62, for guiding high temperature air generated from a heat exchanger to flow into the air tank 60; and a hollow air distribution chamber 63, having a plurality of air holes 64 to be arranged at a surface of the air distribution chamber 63 facing toward the main air chamber 61, being arranged at a position between the main air chamber 61 and the air duct 62. wherein the flowing speed of the high temperature air is first being reduced by the operation of the air distribution chamber 63, and then the high temperature air is enabled to flow into the main air chamber 61 homogeneously through the plural air holes 64. Moreover, the air tank 60 further comprises an after-burn chamber 65, being arranged at an end thereof away from the fuel tank 70, for enabling residual fuel and air to burn therein. Since the electrochemical reaction proceeding in the fuel cell stack as the fuel and air flowing across the two fuel cell cassettes 50, 50a can cause the temperature of the fuel cell stack to be raised to the range between 700° C. to 900° C., a burning effect can be caused instantly as soon as the residual fuel, which is mostly composed of hydrogen, is mixed with air in the after-burn chamber 65. In addition, the size of the air duct 62 and the amount of air duct can be adjusted to optimize the air to be homogeneously distributed. Please refer to FIG. 1A, which shows an assembly of a modularized solid oxide fuel cell stack with two air ducts 62, 62a according to another preferred embodiment of the present invention. The air duct 62 is arranged at a side of the air tank 60 while another air duct 62a is arranged at the opposite side of the air tank 60. It is noted that the means for connecting the air duct 62a to the air tank 60 is similar to that of air duct 62 and thus is not described further herein. The symmetrical disposition of air ducts 62, 62a on the air tank 60 can increase the homogeneity of high temperature air to be distributed in the main air chamber 61.

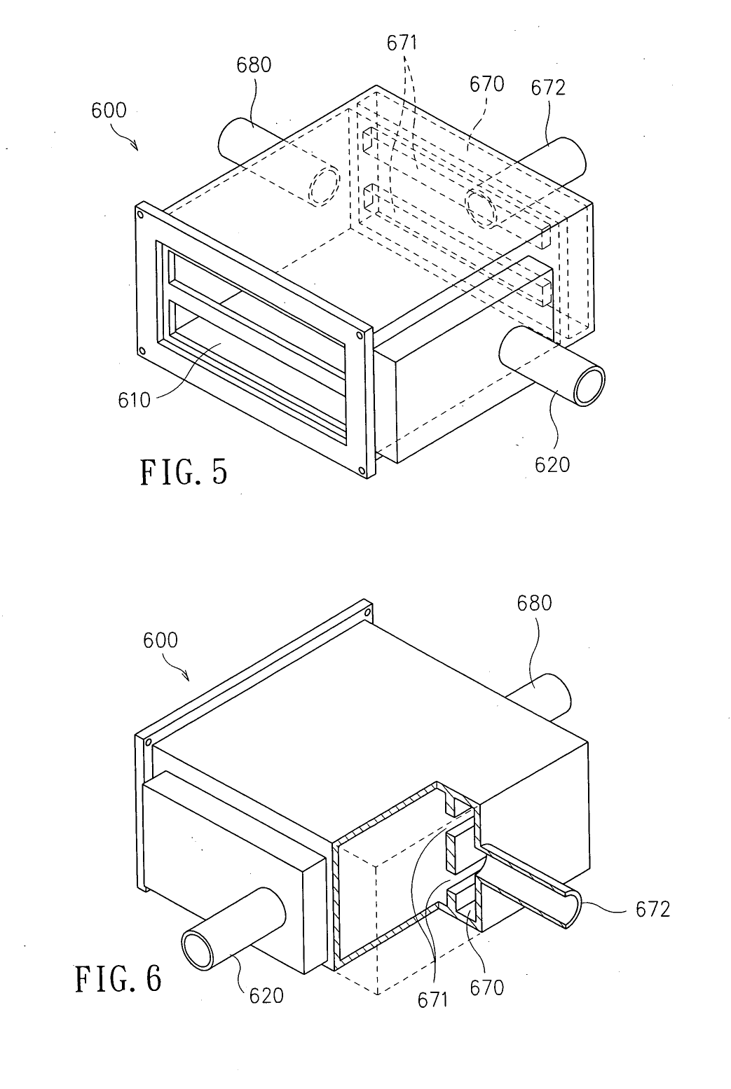

Please refer to FIG. 5 and FIG. 6, which are respectively a three dimensional view of an air tank and a back view thereof according to a preferred embodiment of the invention. The characteristic of the air tank 600 is that the air and residual fuel can be fed into an after-burn chamber separately. In order to separate the residual fuel from the air, a residual fuel chamber 670 is arranged at the back of the main air chamber 610, whereas the grooves 671 arranged at a side of the residual fuel chamber 670 facing toward the main air chamber 610 is used to connected to the back end of the corresponding fuel cell cassette. For ensuring all the residual fuel to enter the residual fuel chamber completely through the grooves 671, airtight mica spacers (not shown in the figures) are added to the joint between the grooves 671 and the corresponding fuel cell cassette. After the residual fuel is collected and accumulated in the residual fuel chamber 670, it is being fed to the after-burn chamber through the fuel exiting duct 680 connecting to the residual fuel chamber 670. Moreover, as air fed into the main air chamber 610 through the air duct 620 is reacted to the fuel cell cassettes, the reacted air is fed into the after-burn chamber by way of an air exiting duct 680. By the configuration described above, the air and residual fuel are fed into an after-burn chamber separately. For either the air tank 60 of FIG. 2 or the air tank 600 of FOG. 5, the after-burn chamber attached at the back of any of the two air tanks 60, 600 can have a porous ceramics arranged therein for enhancing the burning efficiency of the residual fuel and the air while enhancing the homogeneity of temperature distribution.

As seen in FIG. 2 and FIG. 4B, there are two mica spacers 91, 92 attached to the front panel 66. The mica spacer 91 is inset in the inner frame 661 of the mica spacer 91 for preventing air from leaking out of the air tank 60 through the gap formed at the joint of the front panel 66 and the fuel cell cassettes 50, 50a and also for preventing the leakage of electricity generated by the two fuel cell cassettes 50, 50a. The mica spacer 92 is inset in another in another inner frame 662 of the front panel 66 for preventing the connecting plates 45, 45a from contacting to the inner frame 662 and thus preventing the leakage of electricity caused thereby. In addition, there is an isolating plate being placed between the connecting plate 45 and the connecting plate 45a for preventing short circuit caused by the contacting of the two plates 45, 45a.

As seen in FIG. 1 and FIG. 2, the fuel tank 70 is connected to the front panel 66 of the air tank 66 by the use of a back panel 74 thereof so as to seal the fuel cell cassettes 50, 50a inside the air tank 60. Moreover, a fuel duct 71 is connected to the fuel tank 70 for guiding high temperature fuel to feed into a hollow fuel distribution chamber 72 formed inside the fuel tank 70, whereas the hollow fuel distribution chamber 72 has a plurality of fuel holes 73 arranged on a side thereof facing toward the fuel cell cassettes 50, 50a. Furthermore, there is a mica spacer 93 to be arranged at the joint of the fuel tank 70 and the air tank 60 so as to isolate the two and prevent leakage.

The function of the set of conductive strips 80 is to conduct current out of the fuel cell stack of the invention, which comprises an anode strip 81 and a cathode strip 82. Both the anode strip 81 and the cathode strip 82 are made of a high temperature resisting material, preferably, similar to that of the cases 40, 40a. The anode strip 81 can be a Y-type clip having an opening 811 arranged on top thereof. As seen in FIG. 4B, by using the opening 811 to clip the extending bar 22a of the lower fuel cell cassette 50a, the current generated from the anode 11a of the lower fuel cell cassette 50a can be conducted out of the fuel cell stack. On the other hand, the cathode strip 82 is fixed to the hole 43 of the connecting plate 45 of the upper fuel cell cassette 50 by a screw 821. For preventing the leakage of fuel caused by the installation of the conducive strips 81, 82, an addition mica space 94 is being arranged between the fuel tank 70 and the spacer 93 for sandwiching the conductive strips 81, 82 between the two mica spacers 93, 94, as shown in FIG. 1.

By the configuration described above, a modularized solid oxide fuel cell stack can be constructed. Operationally, as high temperature fuel is fed into the stack through the fuel duct 71 while hot air is guided into the same through the air duct 62, electricity can be output by the operation of the anode strip 81 and the cathode strip 82. Thereafter, the reacted air and residual fuel can be guided to the after-burn chamber 65 disposed at the back of the air tank 60, where the residual fuel is burning out for generating high temperature exhaust gas to be discharged and recycled. As the configuration of replaceable fuel cell cassettes in the fuel cell stack of the invention, accordingly, if one fuel cell cassette must be removed and replaced, such as for testing or maintenance, the remaining fuel cell cassettes will not destroyed in the process. This leads to significant saving in time and money.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. An modularized solid oxide fuel cell stack, comprising:
at least a fuel cell cassette; further comprising a planar fuel cell and a hollow case, being used for receiving the planar fuel cell.
an air tank, having a main air chamber for receiving each fuel cell cassette, capable of providing air to the fuel cell stack;
a fuel tank, for providing fuel to the fuel cell stack; and
a set of conducting strips, connecting to each fuel cell cassette for transmitting electricity out of the fuel cell stack.

2. The modularized solid oxide fuel cell stack of claim 1, wherein the planar fuel cell further comprises:
two membrane electrode assembly (MEA), each having an anode, a cathode, and a solid electrolyte, while enabling the anode of one of the two MEAs to be placed facing the anode of another MEA; and
a nickel mesh with an extending bar, sandwiched between the two MEAs;
wherein the case is enabled to contact to the cathodes of the two MEAs and the extending bar is enable to extrude out of the case as the planar fuel cell is received in the case.

3. The modularized solid oxide fuel cell stack of claim 2, wherein a plurality of serial-connected fuel cell cassettes are received in the modularized solid oxide fuel cell stack, and the serial connection is achieved by connecting the extending bar of the nickel mesh of any one of the plural fuel cell cassette to the case of a neighbor fuel cell cassette, and thereby, the output voltage of the modularized solid oxide fuel cell stack is increased.

4. The modularized solid oxide fuel cell stack of claim 2, wherein a connecting plate is arranged in front of the case, and the dimension of the connecting plate is larger than that of the cross section of the case while an air tight seal is place at the interface of the connecting plate and each planar fuel cell.

5. The modularized solid oxide fuel cell stack of claim 1, wherein the case of each fuel cell cassette further has a plurality of manifolds arranged on the top and bottom thereof, for guiding air to flow and distribute uniformly along the cathodes of the corresponding planar fuel cell received therein.

6. The modularized solid oxide fuel cell stack of claim 1, wherein the case is made of a material selected form the group consisting of non-precious metal of stainless steel, etc., high temperature resisting materials of Inconel 600/625, etc., and conductive materials with thermal expansion coefficient similarly to that of the planar fuel cell.

7. The modularized solid oxide fuel cell stack of claim 1, wherein the air tank further comprises:
a main air chamber;
at least a air duct, for guiding high temperature air to flow into the air tank; and
a hollow air distribution chamber, having a plurality of air holes to be arranged at a surface of the air distribution chamber facing toward the main air chamber, being arranged at a position between the main air chamber and the air duct.

8. The modularized solid oxide fuel cell stack of claim 1, wherein the fuel tank further comprises:
a hollow fuel distribution chamber, having a plurality of fuel holes arranged on a side thereof opposite to another surface thereof connecting to a fuel duct; and
the fuel duct, connected to the fuel distribution chamber for guiding high temperature fuel to flow into the same.

9. The modularized solid oxide fuel cell stack of claim 1, wherein an air react channel is formed between the air tank and the cathode of fuel cell cassette, and a fuel reaction channel is formed between the fuel tank and the anode of the fuel cell cassette, whereas an air tight seal for isolating the air react channel from the fuel reaction channel while keeping both air tight.

10. The modularized solid oxide fuel cell stack of claim 1, wherein the air tank further comprises an after-burn chamber, for enabling residual fuel and air to burn therein.

11. The modularized solid oxide fuel cell stack of claim 10, wherein the after-burn chamber further comprises a porous ceramics arranged therein for enhancing the burning efficiency of the residual fuel and the air while enhancing the homogeneity of temperature distribution.

12. The modularized solid oxide fuel cell stack of claim 1, wherein the fuel tank further comprises a residual fuel chamber with a fuel exiting duct, the residual fuel chamber being connected to each fuel cell cassette for collecting and accumulating the residual fuel to be guided out of the fuel tank by the fuel exiting duct, and the air tank further comprises an air exiting duct for guiding reacted air of each fuel cell cassette out of the air tank.

13. The modularized solid oxide fuel cell stack of claim 12, wherein the residual fuel and the reacted air is guided into an after-burn chamber to be burned.

14. The modularized solid oxide fuel cell stack of claim 13, wherein the after-burn chamber further comprises a porous ceramics arranged therein for enhancing the burning efficiency of the residual fuel and the air while enhancing the homogeneity of temperature distribution.

15. The modularized solid oxide fuel cell stack of claim 1, wherein each conductive strips is made of a metal of high temperature resistance.

16. A fuel cell cassette for a modularized solid oxide fuel cell stack, comprising:
two membrane electrode assembly (MEA), each having an anode, a cathode, and a solid electrolyte, while enabling the anode of one of the two MEAs to be placed facing the anode of another MEA;
a nickel mesh with an extending bar, sandwiched between the two MEAs; and
a hollow case, for receiving a planar fuel cell comprises of the two MEAs and the nickel mesh;
wherein the case is enabled to contact to the cathodes of the two MEAs and the extending bar is enable to extrude out of the case as the planar fuel cell is received in the case.

17. The fuel cell cassette of claim 16, wherein a plurality of serial-connected fuel cell cassettes are received in the modularized solid oxide fuel cell stack, and the serial connection is achieved by connecting the extending bar of the nickel mesh of any one of the plural fuel cell cassette to the case of a neighbor fuel cell cassette, and thereby, the output voltage of the modularized solid oxide fuel cell stack is increased.

18. The fuel cell cassette of claim 16, wherein a connecting plate is arranged in front of the case, and the dimension of the connecting plate is larger than that of the cross section of the case while an air tight seal is place at the interface of the connecting plate and each planar fuel cell.

19. The fuel cell cassette of claim 16, wherein the case further has a plurality of manifolds arranged on the top and bottom thereof, for guiding air to flow and distribute uniformly along the cathodes of the corresponding planar fuel cell received therein.

20. The fuel cell cassette of claim 16, wherein the case is made of a material selected form the group consisting of non-precious metal of stainless steel, etc., high temperature resisting materials of Inconel 600/625, etc., and conductive materials with thermal expansion coefficient similarly to that of the planar fuel cell.
